(19) United States
(12) Patent Application Publication
(10) Pub. No.: US 2025/0388716 A1
(43) Pub. Date: Dec. 25, 2025

(54) DUAL-CURED PHOTOSENSITIVE RESIN, PREPARATION METHOD AND APPLICATION THEREOF

(71) Applicant: Zhejiang University, Hangzhou (CN)

(72) Inventors: Jingjun WU, Hangzhou (CN); Tao XIE, Hangzhou (CN); Zizheng FANG, Hangzhou (CN); Qian ZHAO, Hangzhou (CN)

(21) Appl. No.: 18/813,119

(22) Filed: Aug. 23, 2024

(30) Foreign Application Priority Data
Jun. 25, 2024 (CN) 202410823865.1

(51) Int. Cl. C08G 18/10; B29C 64/124; B29C 71/02; B29K 75/00; B33Y 10/00; B33Y 40/20; C08G 18/81

(52) U.S. Cl. CPC C08G 18/10; B29C 64/124; B29C 71/02; B33Y 10/00; B33Y 40/20; C08G 18/8175; B29K 2075/02; C08G 2150/00; C08G 2170/00

(57) ABSTRACT

The disclosure provides a dual-cured photosensitive resin, a preparation method and an application thereof, and belongs to the technical field of polymer materials. Raw materials of the dual-cured photosensitive resin according to the disclosure include a polyurethane acrylate prepolymer bearing hindered urea bonds, a blocked diamine chain extender, a reactive diluent and a photoinitiator; and the blocked diamine chain extender is obtained by reacting a diamine chain extender with one of di-tert-butyl dicarbonate, acid and inorganic salt.

### CROSS-REFERENCE TO RELATED APPLICATIONS

This application claims priority to Chinese Patent Application No. 202410823865.1, filed on Jun. 25, 2024, the contents of which are hereby incorporated by reference.

### TECHNICAL FIELD

The disclosure belongs to the technical field of polymer materials, and in particular to a dual-cured photosensitive resin, a preparation method and an application thereof.

### BACKGROUND

Photo-curing (free radical initiated photo-curing) refers to the photo-induced curing process of monomers and oligomers, and the essence is photo-induced polymerization and crosslinking reaction. Photo-curing technology has the characteristics of high efficiency, wide adaptability, economy, energy saving and environmental protection. Photo-curing coatings are an example of large-scale successful application of photo-curing technology in industry, and the largest product in the field of photo-curing industry. In addition, photo-curing technology is also used in inks, adhesives, photoresist, 3D printing and other fields.

Chemically, the monomers used in photo-curing are mainly acrylate or methacrylate compounds (usually acrylate or methacrylate compounds with functionality greater than or equal to 2), and the oligomers used mainly include polyester acrylate, polyurethane acrylate and epoxy acrylate. A three-dimensional polymer network structure, also known as thermosetting polymer, is formed by photo-curing. Generally, the polymer formed by photo-curing has poor mechanical properties due to its high crosslinking density, which is manifested in brittleness and poor toughness.

The patent with the application number of CN201910790012.1 discloses a dual-cured polyurethane acrylate oligomer, the molecular structure of which contains dissociable hindered urea bonds. After photo-curing, the hindered urea bonds of the polyurethane acrylate oligomer will dissociate, and the exposed isocyanate groups will react with water vapor, resulting in changes in the network structure characteristics of the material, such as molecular structure and crosslinking density. Finally, the mechanical properties of the material will be changed and the toughness will be greatly improved. The patent with the application number of CN202110198554.7 discloses a polyurea acrylate oligomer, where the oligomer also contains dissociable hindered urea bonds. After photo-curing, the hindered urea bonds of the polyurea acrylate oligomer dissociate, and the isocyanate groups generated in the system will react with the urea bonds existing in the system (without the action of water vapor), thus changing the molecular structure and mechanical properties. However, although the photosensitive resin disclosed in the above-mentioned prior art has a dual curing mechanism, it is one component (1K) in terms of material form. From another perspective, the dual curing resin obtained above has the same storage stability as the single-component photosensitive resin with a conventional single photo-curing mechanism, and may be applied to two common photo-curing 3D printing devices of digital light processing (DLP) and stereo lithography apparatus (SLA) at the same time. American Carbon Corporation proposed a dual-cured photosensitive resin (application number is CN201680050991.1), and the prepared material is in the form of two component (2K), in which one component is polyurethane acrylate bearing hindered urea bonds and the other component is polyol/polyamine chain extender, and the above two components are mixed according to a certain proportion, and then photo curing or photo curing 3D printing is carried out, and then heating treatment is carried out. During the heating treatment, the hindered urea bonds are broken, exposing isocyanate groups, and carrying out chain extension reaction with the free polyol/polyamine chain extender in the system to obtain polyurethane, thereby improving the toughness of the material. However, the dual-cured photosensitive resin proposed by American Carbon Corporation must be made into two-component form and mixed before use, because polyol/polyamine may have Michael addition reaction with the double bond in polyurethane acrylate, thus leading to poor storage stability of the system. Because of this, the dual-cured photosensitive resin may not be applied to SLA photo-curing 3D printing process which needs to feed dozens or hundreds of kilograms at one time.

In principle, all the patents mentioned above mentioned polyurethane acrylate bearing hindered urea bonds, the purpose is actually to temporarily block isocyanate to prevent isocyanate from reacting with active hydrogen in molecular structure or active hydrogen in free chain extender. Then, if the polyol/polyamine chain extender may also be blocked to prevent its addition reaction with the double bond in polyurethane acrylate, the material form of two component in the patent of 201680050991.1 may be transformed into a single component, which may adapt to all photo curing 3D printing technologies including SLA.

### SUMMARY

In order to solve the above technical problems, the disclosure provides a dual-cured photosensitive resin, a preparation method and an application thereof, and the photosensitive resin may be stored and used in a single-component form. After photo-curing, through heat treatment, the network structure characteristics such as molecular structure and crosslinking density change, forming an interpenetrating network, and the mechanical properties are also enhanced.

In order to achieve the above objective, the disclosure provides a dual-cured photosensitive resin, including polyurethane acrylate prepolymer bearing hindered urea bonds and a blocked diamine chain extender;

the blocked diamine chain extender is obtained by reacting a diamine chain extender with one of di-tert-butyl dicarbonate, acid and inorganic salt.

The polyurethane acrylate prepolymer bearing hindered urea bonds is actually a temporary protection for isocyanate groups, and meanwhile provides photo-cured reactive groups (acrylate), so it may also be called reactive blocked diisocyanate; the blocked diamine chain extender is a temporary protection of amino group, and isocyanate and amino group are the two groups that react in the subsequent heat treatment process. At the same time, the diamine chain extender is blocked and protected to avoid the problem of failure of the resin material due to the Michael addition reaction of the amino group therein with the acrylate group in the urethane acrylate prepolymer during storage or use.

In an embodiment, the diamine chain extender is aliphatic diamine, alicyclic diamine or aromatic diamine.

In an embodiment, the diamine chain extender is aromatic diamine.

In an embodiment, the diamine chain extender is one of 4,4′-methylene bis(2-chloroaniline) (MOCA, structural formula is

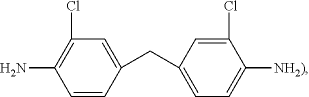

4,4′-diphenylmethane diamine (MDA, structural formula is

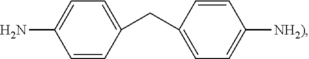

p-phenylenediamine (PPDA, structural formula is

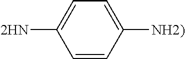

and 4,4′-methylene dicyclohexylamine (PACM, structural formula is

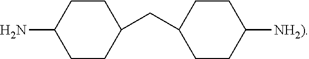

In an embodiment, the blocked diamine chain extender is obtained by reacting a diamine chain extender (structural formula is H₂N—R—NH₂, where R represents aliphatic, alicyclic or aromatic group) with di-tert-butyl dicarbonate, and the reaction equation is as follows:

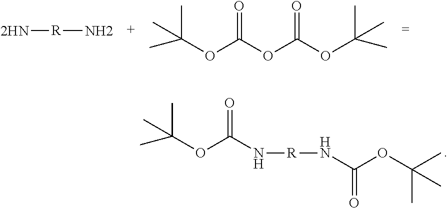

In an embodiment, the blocked diamine chain extender is composed of diamine chain extender (structural formula is H₂N—R—NH₂, where R represents aliphatic, alicyclic or aromatic group) and acid, and the reaction equation is as follows:

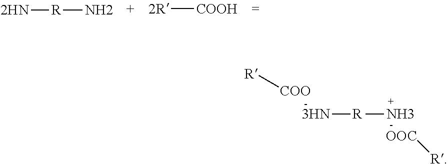

In an embodiment, the acid (structural formula is R′—COOH) is one or more of acetic acid, citric acid, formic acid and oxalic acid, and further optionally, the acid is acetic acid.

In an embodiment, the blocked diamine chain extender is obtained by reacting a diamine chain extender (structural formula is H₂N—R—NH₂, where R represents aliphatic, alicyclic or aromatic group) with inorganic salt (M_{y}X_{z}), and the reaction equation is as follows:

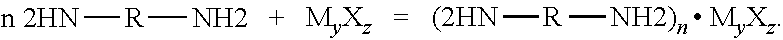

In an embodiment, the inorganic salt is one or more of sodium chloride, magnesium chloride, aluminum chloride and calcium chloride, and further optionally, the inorganic salt is sodium chloride.

In an embodiment, the blocked diamine chain extender releases amino groups under heating conditions, specifically:
when the blocked diamine chain extender is obtained by the reaction of diamine chain extender and di-tert-butyl dicarbonate and heated under acidic conditions (temperature greater than 120 degrees Celsius (° C.)), the following reaction occurs:

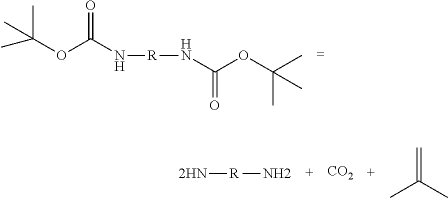

(heating to above 120° C. under acidic conditions);
when the blocked diamine chain extender is obtained by the reaction of diamine chain extender with acid, the following reaction occurs under the condition of heating (temperature greater than 100° C.):

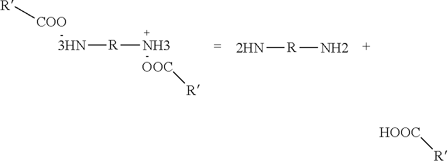

(the reaction condition is heating to 100° C.); and
when the blocked diamine chain extender is obtained by the reaction of diamine chain extender and inorganic salt, the following reaction occurs under the condition of heating (temperature greater than 100° C.):

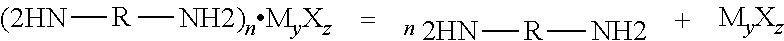

(the reaction condition is heating to 100° C.).

In an embodiment, the molar ratio of the polyurethane acrylate prepolymer bearing hindered urea bonds to the blocked diamine chain extender is 1:1.

In an embodiment, the polyurethane acrylate prepolymer bearing hindered urea bonds may release isocyanate groups under heating conditions, and the structural formula is:

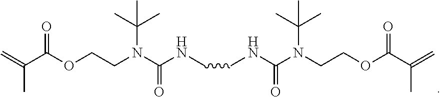 [SMILES: C=C(C)C(=O)OCCN(C(=O)NCCNC(=O)N(CCOC(=O)C(=C)C)C(C)(C)C)C(C)(C)C]

where, the symbol “ [symbol] ” does not represent a carbon chain, and the specific structure of the symbol depends on the structure of monomer raw materials.

In an embodiment, the polyurethane acrylate prepolymer bearing hindered urea bonds is obtained by reacting polyol, polyisocyanate and tert-butyl aminoethyl methacrylate, and the reaction formula is as follows:

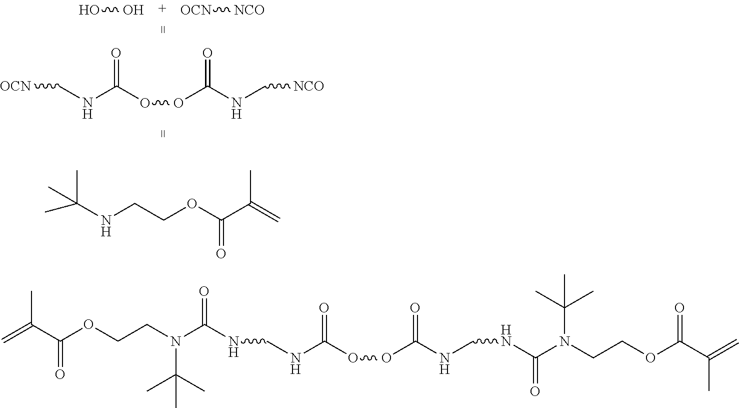

In an embodiment, the relationship between the molar amounts of polyol, polyisocyanate and tert-butyl aminoethyl methacrylate is: n polyol*hydroxyl functionality+n tert-butyl aminoethyl methacrylate=n polyisocyanate*isocyanate functionality, where n is a natural number that is not 0.

In an embodiment, the raw materials also include a reactive diluent and a photoinitiator for adjusting viscosity and performance.

In an embodiment, the reactive diluent is a mono-functional or multifunctional acrylate or methacrylate low-viscosity monomer, and the type and content of the reactive diluent may be adjusted according to the mechanical performance required.

In an embodiment, the photoinitiator is a kind of substance that crackes under light with a specific wavelength to generate free radicals, thereby initiating double bond polymerization. In practical application, the matching photoinitiator should be selected according to the wavelength of the light source used. Especially, for photo-curing 3D printing, the wavelengths of light sources usually used are 355 nanometer (nm), 365 nm and 405 nm, so the photoinitiator used is further optionally one or more of trimethyl benzoyl-diphenyl phosphine oxide (TPO), bis(2,4,6-trimethyl benzoyl) phenyl phosphine oxide (819) and 1-hydroxycyclohexyl benzophenone (184).

The disclosure also provides a preparation method of the dual-cured photosensitive resin, including: uniformly mixing raw materials of polyurethane acrylate prepolymer bearing hindered urea bonds, a blocked diamine chain extender, a reactive diluent and a photoinitiator to obtain the dual-cured photosensitive resin.

The storage temperature of the dual-cured photosensitive resin prepared by the disclosure must be below the deblocking temperature of the polyurethane acrylate prepolymer bearing hindered urea bonds and the blocked diamine chain extender.

Optionally, the storage temperature of the photosensitive resin should be 20° C. lower than the deblocking temperature of the polyurethane acrylate prepolymer bearing hindered urea bonds and the blocked diamine chain extender. Further optionally, the storage temperature of the photosensitive resin should be lower than the deblocking temperature of the polyurethane acrylate prepolymer bearing hindered urea bonds and the blocked diamine chain extender by 50° C.

The disclosure also provides an application of the dual-cured photosensitive resin in preparing coatings, inks or adhesives, and the dual-cured photosensitive resin needs to be subjected to heat treatment after photo-curing, and the heat treatment is performed at a temperature of 100-140° C. for a duration of 30 minutes (min)-4 hours (h).

In an embodiment, the photosensitive resin is coated on the surface of a workpiece by means of brush coating, roller coating, spray coating, etc., and then photo-cured by using a light source with a specific wavelength; after that, the cured workpiece is put into an oven for heating treatment, where the heat treatment temperature and heating duration are adjusted according to different kinds of blocked diamine chain extenders, where for a diamine chain extender system using di-tert-butyl dicarbonate as a blocking agent, the heat treatment temperature should be greater than 120° C. and the heat treatment duration should be 30 min-4 h, and for a diamine chain extender system using acid or salt as a blocking agent, the heat treatment temperature should be greater than 100° C. and the heat treatment duration should be 30 min-4 h.

The disclosure also provides an application of the dual-cured photosensitive resin in photo-curing 3D printing. The photo-curing 3D printing includes printing with top-down SLA and bottom-up DLP or laser cladding deposition (LCD) 3D printing equipment, and performing heat treatment after printing and molding, where the heat treatment temperature is 100-140° C. and the duration is 30 min-4 h.

In an embodiment, the initiator in the photosensitive resin needs to be adjusted according to the wavelengths of the light sources of different printing equipment. For SLA, the light source wavelength is usually 355 nm, so the initiator in photosensitive resin is further optionally 1-hydroxycyclohexyl benzophenone (184). For DLP or LCD, the light source wavelength is usually 385 nm and 405 nm, so the initiator in photosensitive resin is further optionally trimethyl benzoyl-diphenyl phosphine oxide (TPO) or bis(2,4,6-trimethyl benzoyl) phenyl phosphine oxide (819).

In an embodiment, the sample obtained by 3D printing needs heat treatment to improve the mechanical performance, where the heating temperature and heating duration are adjusted according to different blocked diamine chain extenders. For the diamine chain extender systems using di-tert-butyl dicarbonate and salt as blocking agents, the heat treatment temperature should be greater than 120° C. and the heat treatment duration should be 30 min-4 h. For the diamine chain extender system using acid as blocking agent, the heat treatment temperature should be greater than 100° C. and the heat treatment duration should be 30 min-4 h.

In an embodiment, the photo-curing process of the dual-cured photosensitive resin is the free radical polymerization of the double bond of the polyurethane acrylate prepolymer bearing hindered urea bonds, and the chemical reaction is as follows:

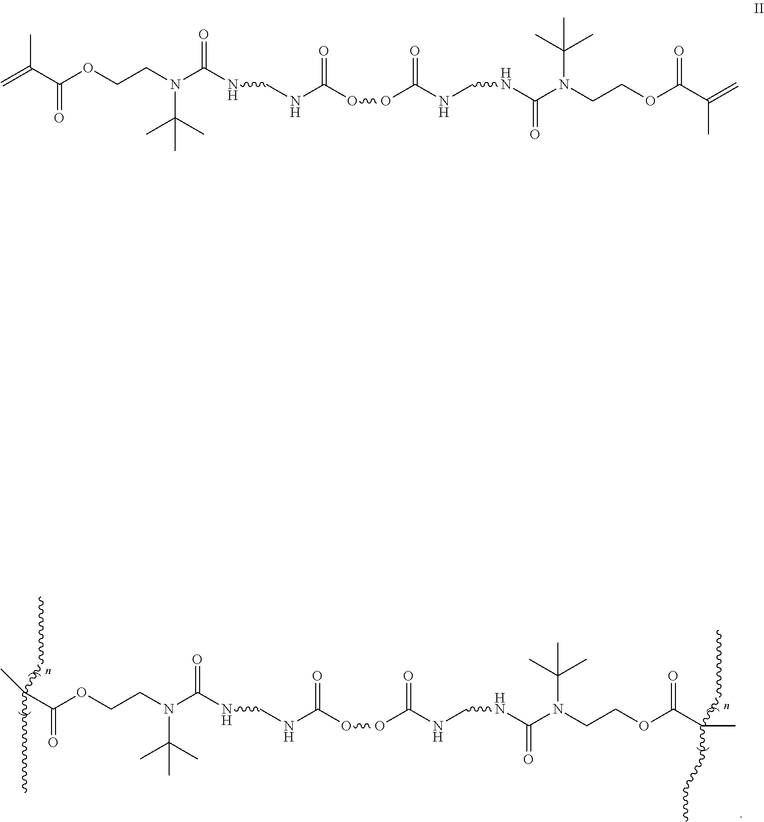

In an embodiment, heat treatment is needed after photo-curing to further improve the mechanical performance. Three reactions occur during the heat treatment, including urea bond dissociation of polyurethane acrylate prepolymer bearing hindered urea bonds (isocyanate-terminated prepolymer, Reaction a is obtained), deblocking of blocked diamine chain extender (Reaction b), and reaction between isocyanate and diamine (Reaction c). The specific reaction equation is as follows:

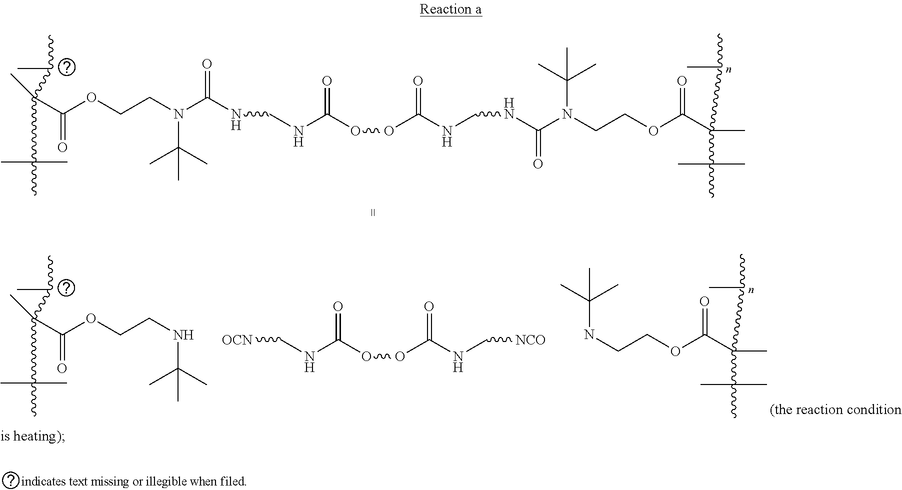

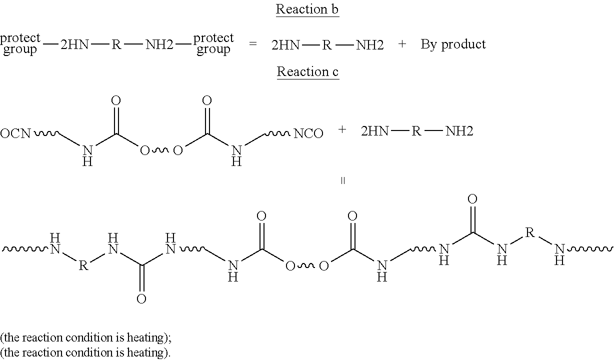

From the above reaction mechanism, it may be seen that the deblocked diamine chain extender reacts with the dissociated polyurethane acrylate prepolymer bearing hindered urea bonds to form polyurea, and improves the performance Therefore, the molar ratio between the blocked diamine chain extender and blocked diisocyanate (polyurethane acrylate prepolymer bearing hindered urea bonds) in the photosensitive resin needs to meet certain conditions. Specifically, in order to ensure the sufficient reaction and the performance of the final material, the molar amount of blocked diamine chain extender is equal to the molar amount of polyurethane acrylate prepolymer bearing hindered urea bonds.

Compared with the prior art, the disclosure has following advantages and technical effects.

Firstly, according to the disclosure, the photosensitive resin is obtained by uniformly mixing the polyurethane acrylate prepolymer bearing hindered urea bonds, the blocked diamine chain extender, the reactive diluent and the photoinitiator, and the photosensitive resin may be stably stored for a long time, and may be stored, sold or used for a long time in the single-component form without mixing before use.

Secondly, the photosensitive resin provided by the disclosure needs heat treatment after photo-curing to improve the material performance.

Thirdly, the dual-cured photosensitive resin provided by the disclosure may be used for both top-down SLA and bottom-up DLP, LCD and other photo-curing 3D printing technologies.

### BRIEF DESCRIPTION OF THE DRAWINGS

The accompanying drawings, which constitute a part of the disclosure, are used to provide a further understanding of the disclosure. The illustrative embodiments and the descriptions of the disclosure are used to explain the disclosure, and do not constitute an improper limitation of the disclosure. In the attached drawings:

FIG. 1 is a graph showing viscosity changes of photosensitive resins in Embodiment 1-Embodiment 7 when stored at room temperature and under closed conditions.

FIG. 2 is a graph showing viscosity changes of photosensitive resins in Comparative example 1-Comparative example 7 when stored at room temperature and under closed conditions.

### DETAILED DESCRIPTION OF THE EMBODIMENTS

A number of exemplary embodiments of the disclosure will now be described in detail, and this detailed description should not be considered as a limitation of the disclosure, but should be understood as a more detailed description of certain aspects, characteristics and embodiments of the disclosure.

It should be understood that the terminology described in the disclosure is only for describing specific embodiments and is not used to limit the disclosure. In addition, for the numerical range in the disclosure, it should be understood that each intermediate value between the upper limit and the lower limit of the range is also specifically disclosed. The intermediate value within any stated value or stated range and every small range between any other stated value or intermediate value within the stated range are also included in the disclosure. The upper limit and the lower limit of these small ranges may be independently included or excluded from the range.

Unless otherwise specified, all technical and scientific terms used herein have the same meaning as commonly understood by one of ordinary skill in the art to which this disclosure relates. Although the disclosure only describes the preferred methods and materials, any methods and materials similar or equivalent to those described herein may also be used in the practice or testing of the disclosure. All documents mentioned in this specification are incorporated by reference to disclose and describe methods and/or materials related to the documents. In case of conflict with any incorporated document, the contents of this specification shall prevail.

It is obvious to those skilled in the art that many improvements and changes may be made to the specific embodiments of the disclosure without departing from the scope or spirit of the disclosure. Other embodiments will be apparent to the skilled person from the specification of the disclosure. The specification and embodiments of the disclosure are exemplary only.

The terms “comprising”, “including”, “having” and “containing” used in this disclosure are all open terms, which means including but not limited to.

The embodiment of the disclosure provides a dual-cured photosensitive resin, and the raw materials include a polyurethane acrylate prepolymer bearing hindered urea bonds and a blocked diamine chain extender;

the blocked diamine chain extender is obtained by reacting a diamine chain extender with one of di-tert-butyl dicarbonate, acid and inorganic salt.

In an embodiment of the disclosure, the diamine chain extender is aliphatic diamine, alicyclic diamine or aromatic diamine. Further optionally, the diamine chain extender is aromatic diamine. Further optionally, the diamine chain extender is one of 4,4′-methylene bis(2-chloroaniline) (MOCA, structural formula is

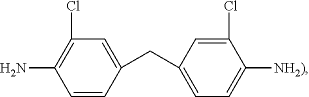

4,4′-diphenylmethane diamine (MDA, structural formula is

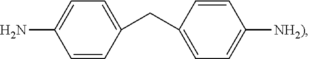

p-phenylenediamine (PPDA, structural formula is

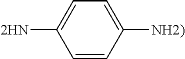

and 4,4′-methylene dicyclohexylamine (PACM, structural formula is

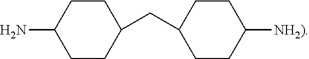

In an embodiment of the disclosure, the blocked diamine chain extender is obtained by reacting a diamine chain extender (structural formula is H₂N—R—NH₂, where R represents aliphatic, alicyclic or aromatic group) with di-tert-butyl dicarbonate, and the reaction equation is as follows:

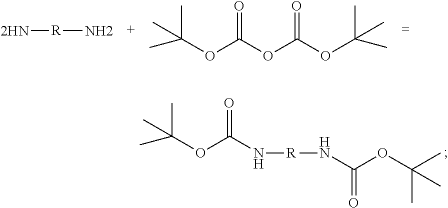

in an embodiment of the disclosure, the blocked diamine chain extender is obtained by reacting a diamine chain extender (structural formula is H₂N—R—NH₂, where R represents aliphatic, alicyclic or aromatic group) with an acid, and the reaction equation is as follows:

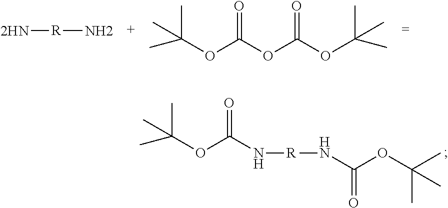

in an embodiment of the disclosure, the acid (structural formula is R′—COOH) is one or more of acetic acid, citric acid, formic acid and oxalic acid, and further optionally, the acid is acetic acid.

In an embodiment of the disclosure, the blocked diamine chain extender is obtained by reacting a diamine chain extender (structural formula is H₂N—R—NH₂, where R represents aliphatic, alicyclic or aromatic group) with inorganic salt (M_{y}X_{z}), and the reaction equation is as follows:

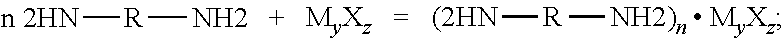

in an embodiment of the disclosure, the inorganic salt is one or more of sodium chloride, magnesium chloride, aluminum chloride and calcium chloride, and further optionally, the inorganic salt is sodium chloride.

In an embodiment of the disclosure, the molar ratio of the polyurethane acrylate prepolymer bearing hindered urea bonds to the blocked diamine chain extender is 1:1.

In an embodiment of the disclosure, the polyurethane acrylate prepolymer bearing hindered urea bonds will release isocyanate groups under heating conditions, and the structural formula is as follows:

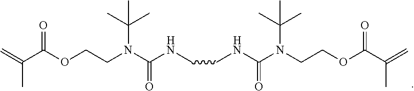 [SMILES: C=C(C)C(=O)OCCN(C(=O)NCCNC(=O)N(CCOC(=O)C(=C)C)C(C)(C)C)C(C)(C)C]

In an embodiment of the disclosure, the raw materials also include a reactive diluent and a photoinitiator for adjusting viscosity and performance.

In an embodiment of the disclosure, the reactive diluent is a mono-functional or multifunctional acrylate or methacrylate low-viscosity monomer, and the type and content of the reactive diluent may be adjusted according to the mechanical performance required.

In an embodiment of the disclosure, the reactive diluent is one or more of EHA (isooctyl acrylate), PEGDA (polyethylene glycol diacrylate), IBOMA (isobornyl methacrylate), TMPTA (trimethylolpropane triacrylate), EHMA (iso-octyl methacrylate) and THFA (tetrahydrofuran acrylate).

In an embodiment of the disclosure, the photoinitiator is a kind of substance that crackes under light with a specific wavelength to generate free radicals, thereby initiating double bond polymerization. In practical application, the matching photoinitiator should be selected according to the wavelength of the light source used. Especially, for photo-curing 3D printing, the wavelengths of light sources usually used are 355 nm, 365 nm and 405 nm, so the photoinitiator used is further optionally one or more of trimethyl benzoyl-diphenyl phosphine oxide (TPO), bis(2,4,6-trimethyl benzoyl) phenyl phosphine oxide (819) and 1-hydroxycyclohexyl benzophenone (184).

The embodiment of the disclosure also provides a preparation method of the dual-cured photosensitive resin, including: uniformly mixing raw materials of polyurethane acrylate prepolymer bearing hindered urea bonds, a blocked diamine chain extender, a reactive diluent and a photoinitiator to obtain the dual-cured photosensitive resin.

The embodiment of the disclosure also provides an application of the dual-cured photosensitive resin in preparing coatings, inks or adhesives, and the dual-cured photosensitive resin needs to be subjected to heat treatment after photo-curing, and the heat treatment is performed at a temperature of 100-140° C. for a duration of 30 min-4 h.

In an embodiment of the disclosure, the photosensitive resin is coated on the surface of a workpiece by means of brush coating, roller coating, spray coating, etc., and then photo-cured by using a light source with a specific wavelength; after that, the cured workpiece is put into an oven for heating treatment, where the heat treatment temperature and heating duration are adjusted according to different kinds of blocked diamine chain extenders, where for a diamine chain extender system using di-tert-butyl dicarbonate as a blocking agent, the heat treatment temperature should be greater than 120° C. and the heat treatment duration should be 30 min-4 h, and for a diamine chain extender system using acid or salt as a blocking agent, the heat treatment temperature should be greater than 100° C. and the heat treatment duration should be 30 min-4 h.

The embodiment of the disclosure also provides an application of the dual-cured photosensitive resin in photo-curing 3D printing. The photo-curing 3D printing includes printing with top-down SLA and bottom-up DLP or LCD 3D printing equipment, and performing heat treatment after printing and molding, where the heat treatment temperature is 100-140° C. and the duration is 30 min-4 h.

In an embodiment of the disclosure, the initiator in the photosensitive resin needs to be adjusted according to the wavelengths of the light sources of different printing equipment. For SLA, the light source wavelength is usually 355 nm, so the initiator in photosensitive resin is further optionally 1-hydroxycyclohexyl benzophenone (184). For DLP or LCD, the light source wavelength is usually 385 nm and 405 nm, so the initiator in photosensitive resin is further optionally trimethyl benzoyl-diphenyl phosphine oxide (TPO) or bis(2,4,6-trimethyl benzoyl) phenyl phosphine oxide (819).

In an embodiment of the disclosure, the sample obtained by 3D printing needs heat treatment to improve the mechanical performance, where the heating temperature and heating duration are adjusted according to different blocked diamine chain extenders. For the diamine chain extender systems using di-tert-butyl dicarbonate and salt as blocking agents, the heat treatment temperature should be greater than 120° C. and the heat treatment duration should be 30 min-4 h. For the diamine chain extender system using acid as blocking agent, the heat treatment temperature should be greater than 100° C. and the heat treatment duration should be 30 min-4 h.

The raw materials used in the embodiments of the disclosure are all commercially available.

The room temperature in the embodiments of the disclosure refers to “25±3° C.”.

The technical scheme of the disclosure will be further explained by following embodiments.

### Embodiment 1

(1) The reaction equation for the preparation of polyurethane acrylate prepolymer bearing hindered urea bonds (PTMG1K-HDI-TBEMA) is as follows:

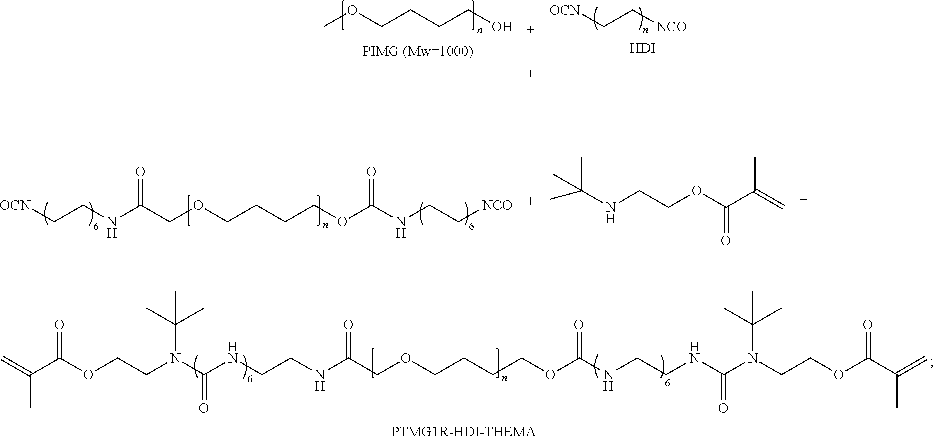

the specific preparation steps are as follows: 100 g of PTMG (polybutylene glycol, Mw=1000) and 336.38 grams (g) of HDI (hexamethylene diisocyanate) are evenly mixed, 1.13 g DBTDL (dibutyltin dilaurate) is added, and the intermediate product PTMG1K-HDI is obtained by stirring at 50° C. for 5 h;
370.54 g TBEMA (tert-butyl aminoethyl methacrylate) is slowly dropped into the intermediate product PTMG1K-HDI, and the mixture is stirred at 50° C. for reacting for 8 h to obtain the above PTMG1k-HDI-TBEMA;
(2) 4,4′-diphenylmethane diamine (MDA) is used as diamine chain extender to prepare a blocked diamine chain extender, and the reaction equation is as follows:

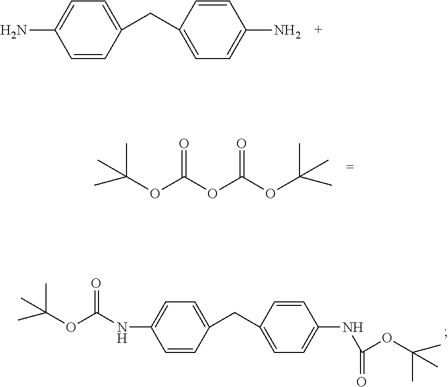 [SMILES: Nc1ccc(Cc2ccc(N)cc2)cc1 ; CC(C)(C)OC(=O)OC(=O)OC(C)(C)C ; CC(C)(C)OC(=O)Nc1ccc(Cc2ccc(NC(=O)OC(C)(C)C)cc2)cc1]

the specific preparation steps are as follows: dissolving 4,4′-diphenylmethane diamine and di-tert-butyl dicarbonate in dichloromethane according to the molar ratio of 1:1.05, adding 1 weight percent (wt %) (that is, 1% of the total mass of 4,4′-diphenylmethane diamine and di-tert-butyl dicarbonate) triethylamine as a catalyst, and stirring at room temperature for 12 h to obtain a product of a blocked diamine chain extender (MDA-BOC);
(3) preparation of dual-cured photosensitive resin:
the PTMG1K-HDI-TBEMA obtained in step (1), MDA-BOC obtained in step (2), EHA (isooctyl acrylate), PEGDA (polyethylene glycol diacrylate) and TPO (trimethyl benzoyl-diphenyl phosphine oxide) are weighed according to the amounts in Table 1, and then mixed uniformly to obtain the dual-cured photosensitive resin.

The dual-cured photosensitive resin prepared in Embodiment 1 is photo-cured and then heat treated at 120° C. for 4 h. The tensile strength, elongation at break and Young's modulus of the obtained product are measured, and the results are shown in Table 1.

TABLE 1
Dosage and performance test results
of raw materials in Embodiment 1

| PTMG1K-HDI-TBEMA | 750 | g |
|---|---|---|
| MDA-BOC | 171.59 | g |
| EHA | 250 | g |
| PEGDA | 30 | g |
| TPO | 15 | g |
| Heat treatment process | Heat treatment at 120° C. for 4 h | |
| Tensile strength | 25 megapascal (MPa) | |
| Elongation at break | 273% | |
| Young's modulus | 21 | MPa |

### Embodiment 2

(1) The preparation method of polyurethane acrylate prepolymer bearing hindered urea bonds (PTMG1K-HDI-TBEMA) is the same as Embodiment 1;
(2) the method of preparing blocked diamine chain extender with 4,4′-diphenylmethane diamine (MDA) as diamine chain extender is the same as Embodiment 1;
(3) preparation of dual-cured photosensitive resin:
the PTMG1K-HDI-IBOMA obtained in step (1), MDA-BOC obtained in step (2), IBOMA (isobornyl methacrylate), TMPTA (trimethylolpropane triacrylate) and TPO are weighed according to the amounts in Table 2, and then mixed uniformly to obtain the dual-cured photosensitive resin.

The dual-cured photosensitive resin prepared in Embodiment 2 is photo-cured and then heat treated at 130° C. for 3 h. The tensile strength, elongation at break and Young's modulus of the obtained product are measured, and the results are shown in Table 2.

TABLE 2
Dosage and performance test results
of raw materials in Embodiment 2

| PTMG1K-HDI-TBEMA | 700 | g |
|---|---|---|
| MDA-BOC | 160.15 | g |
| IBOMA | 300 | g |
| TMPTA | 20 | g |
| TPO | 10 | g |
| Heat treatment process | Heat treatment at 130° C. for 3 h | |
| Tensile strength | 32 | MPa |
| Elongation at break | 186% | |
| Young's modulus | 286 | MPa |

### Embodiment 3

(1) The preparation method of polyurethane acrylate prepolymer bearing hindered urea bonds (PTMG1K-HDI-TBEMA) is the same as Embodiment 1;
(2) the method of preparing blocked diamine chain extender with 4,4′-diphenylmethane diamine (MDA) as diamine chain extender is the same as Embodiment 1;
(3) preparation of dual-cured photosensitive resin:

the PTMG1K-HDI-IBOMA obtained in step (1), MDA-BOC obtained in step (2), IBOMA (isobornyl methacrylate), TMPTA (trimethylolpropane triacrylate) and TPO are weighed according to the amounts in Table 3, and then mixed uniformly to obtain the dual-cured photosensitive resin.

The dual-cured photosensitive resin prepared in Embodiment 3 is photo-cured and then heat treated at 120° C. for 4 h. The tensile strength, elongation at break and Young's modulus of the obtained product are measured, and the results are shown in Table 3.

TABLE 3
Dosage and performance test results
of raw materials in Embodiment 3

| PTMG1K-HDI-TBEMA | 700 | g |
|---|---|---|
| MDA-BOC | 127.94 | g |
| IBOMA | 300 | g |
| TMPTA | 20 | g |
| TPO | 10 | g |
| Heat treatment process | Heat treatment at 120° C. for 4 h | |
| Tensile strength | 29 | MPa |
| Elongation at break | 203% | |
| Young's modulus | 257 | MPa |

### Embodiment 4

(1) The preparation method of polyurethane acrylate prepolymer bearing hindered urea bonds (PTMG1K-HDI-TBEMA) is the same as Embodiment 1;
(2) 4,4′-diphenylmethane diamine (MDA) is used as diamine chain extender to prepare a blocked diamine chain extender, and the reaction equation is as follows:

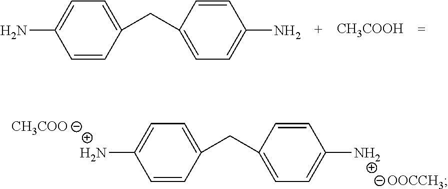

the specific preparation steps are as follows: dissolving 4,4′-diphenylmethane diamine in dichloromethane, keeping the temperature at 0° C., then dropping twice the molar amount of acetic acid, and collecting the precipitate, namely the blocked diamine chain extender (MDA-EA);
(3) preparation of dual-cured photosensitive resin:
the PTMG1K-HDI-TBEMA obtained in step (1), MDA-EA obtained in step (2), EHMA (iso-octyl methacrylate), TMPTA (trimethylolpropane triacrylate) and TPO are weighed according to the amounts in Table 4, and then mixed uniformly to obtain the dual-cured photosensitive resin.

The dual-cured photosensitive resin prepared in Embodiment 4 is photo-cured and then heat treated at 120° C. for 0.5 h. The tensile strength, elongation at break and Young's modulus of the obtained product are measured, and the results are shown in Table 4.

TABLE 4
Dosage and performance test results
of raw materials in Embodiment 4

| | | |
|---|---|---|
| PTMG1K-HDI-TBEMA | 750 | g |
| MDA-EA | 137.08 | g |
| EHMA | 250 | g |
| TMPTA | 20 | g |
| TPO | 30 | g |

| | |
|---|---|
| Heat treatment process | Heat treatment at 120° C. for 0.5 h |

| | | |
|---|---|---|
| Tensile strength | 13 | MPa |

| | |
|---|---|
| Elongation at break | 163% |

| | | |
|---|---|---|
| Young's modulus | 12 | MPa |

### Embodiment 5

(1) The preparation method of polyurethane acrylate prepolymer bearing hindered urea bonds (PTMG1K-HDI-TBEMA) is the same as Embodiment 1;
(2) the method of preparing blocked diamine chain extender with 4,4′-diphenylmethane diamine (MDA) as diamine chain extender is the same as Embodiment 4;
(3) preparation of dual-cured photosensitive resin:
the PTMG1K-HDI-TBEMA obtained in step (1), MDA-EA obtained in step (2), EHA (isooctyl acrylate), TMPTA (trimethylolpropane triacrylate) and TPO are weighed according to the amounts in Table 5, and then uniformly mixed to obtain the dual-cured photosensitive resin.

The dual-cured photosensitive resin prepared in Embodiment 5 is photo-cured and then heat treated at 120° C. for 3 h. The tensile strength, elongation at break and Young's modulus of the obtained product are measured, and the results are shown in Table 5.

TABLE 5
Dosage and performance test results
of raw materials in Embodiment 5

| PTMG1K-HDI-TBEMA | 750 | g |
|---|---|---|
| MDA-NaCl | 93.75 | g |
| EHA | 250 | g |
| TMPTA | 15 | g |
| TPO | 10 | g |
| Heat treatment process | Heat treatment at 120° C. for 3 h | |
| Tensile strength | 26 | MPa |
| Elongation at break | 427% | |
| Young's modulus | 17 | MPa |

### Embodiment 6

(1) The preparation method of polyurethane acrylate prepolymer bearing hindered urea bonds (PTMG1K-HDI-TBEMA) is the same as Embodiment 1;
(2) 4,4′-diphenylmethane diamine (MDA) is used as diamine chain extender to prepare a blocked diamine chain extender, and the reaction equation is as follows:

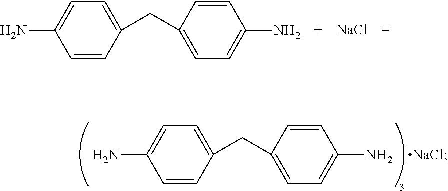

the specific preparation steps are as follows: putting the saturated aqueous solution of 4,4′-diphenylmethane diamine and sodium chloride in a small ball mill with cooling at a molar ratio of 3:1, ball milling for 7 h, then washing with water twice, then washing with benzene chloride twice, drying, and pulverizing with a jet mill to obtain the product of the blocked diamine chain extender (MDA-NaCl);
(3) preparation of dual-cured photosensitive resin:
the PTMG1K-HDI-TBEMA obtained in step (1), MDA-NaCl obtained in step (2), THFA (tetrahydrofuran acrylate), TMPTA (trimethylolpropane triacrylate) and TPO are weighed according to the amounts in Table 6, and then mixed uniformly to obtain the dual-cured photosensitive resin.

The dual-cured photosensitive resin prepared in Embodiment 6 is photo-cured and then heat treated at 130° C. for 2 h. The tensile strength, elongation at break and Young's modulus of the obtained product are measured, and the results are shown in Table 6.

TABLE 6
Dosage and performance test results
of raw materials in Embodiment 6

| PTMG1K-HDI-TBEMA | 750 | g |
|---|---|---|
| MDA-NaCl | 93.75 | g |
| THFA | 250 | g |
| TMPTA | 25 | g |
| TPO | 25 | g |
| Heat treatment process | Treatment at 130° C. for 2 h | |
| Tensile strength | 29 | MPa |
| Elongation at break | 389% | |
| Young's modulus | 22 | MPa |

### Embodiment 7

(1) The preparation method of polyurethane acrylate prepolymer bearing hindered urea bonds (PTMG1K-HDI-TBEMA) is the same as Embodiment 1;
(2) the method of preparing blocked diamine chain extender with 4,4′-diphenylmethane diamine (MDA) as diamine chain extender is the same as Embodiment 6;
(3) preparation of dual-cured photosensitive resin:
the PTMG1K-HDI-IBOMA obtained in step (1), MDA-NaCl obtained in step (2), IBOMA (isobornyl methacrylate), TMPTA (trimethylolpropane triacrylate) and TPO are weighed according to the amounts shown in Table 7, and then mixed uniformly to obtain the dual-cured photosensitive resin.

The dual-cured photosensitive resin prepared in Embodiment 7 is printed into standard tensile spline (ISO527) by using a DLP photo-curing 3D printer with a wavelength of 405 nm. In order to match the printer, the photoinitiator in the photosensitive resin in this embodiment is TPO, and the curing energy range is 10 millijoules per square centimeter (mJ/cm²)-100 mJ/cm². After photo-curing and heat treatment at 120° C. for 1 h, the tensile strength, elongation at break and Young's modulus of the obtained product are measured, and the results are shown in Table 7.

TABLE 7
Dosage and performance test results
of raw materials in Embodiment 7

| PTMG1K-HDI-TBEMA | 800 | g |
|---|---|---|
| MDA-NaCl | 100.01 | g |
| IBOMA | 200 | g |
| TMPTA | 50 | g |
| TPO | 5 | g |
| Heat treatment process | Heat treatment at 120° C. for 1 h | |
| Tensile strength | 35 | MPa |
| Elongation at break | 128% | |
| Young's modulus | 479 | MPa |

### Storage Stability Test

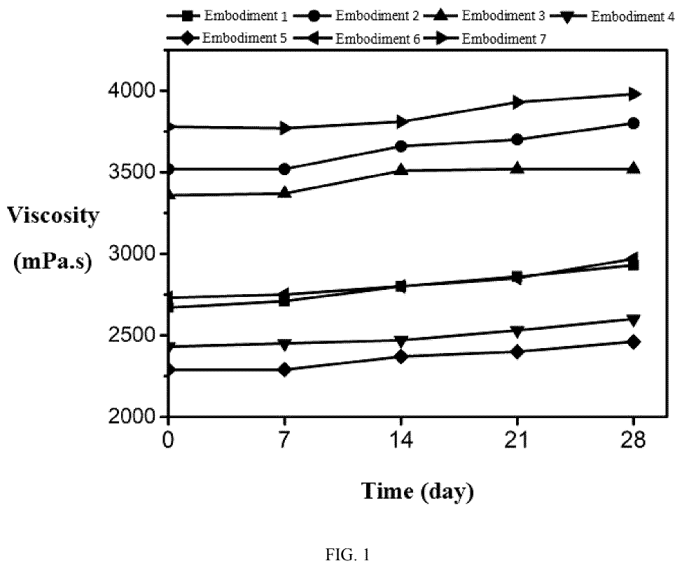

The dual-cured photosensitive resins prepared in Embodiment 1-Embodiment 7 are stored at room temperature and sealed conditions, and the viscosity changes are shown in FIG. 1. As may be seen from FIG. 1, all the photosensitive resins in Embodiment 1-Embodiment 7 have good storage stability, which is due to the single-component form.

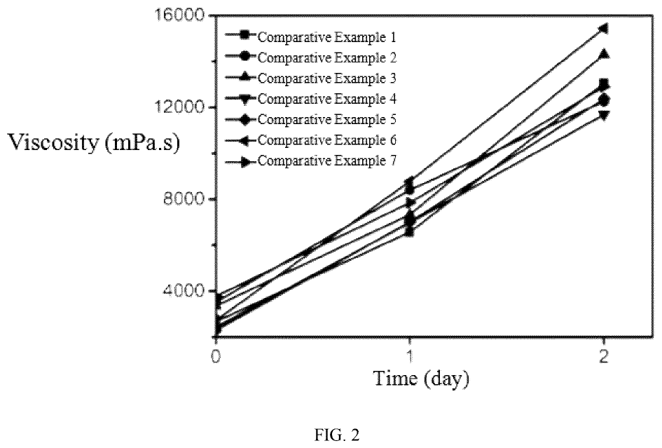

The blocked diamine chain extenders in the photosensitive resins of Embodiment 1-Embodiment 7 are replaced by deblocked diamine chain extenders in equal quantities (that is, all of the blocked diamine chain extenders are replaced by MDA with the same mass), and the obtained photosensitive resins are recorded as Comparative example 1-Comparative example 7, respectively, and stored under normal temperature and sealed conditions, and the viscosity changes are shown in FIG. 2. From FIG. 2, it may be seen that when the diamine chain extenders are not protected by blocking, the viscosity of the photosensitive resins may increase rapidly during storage, resulting in the unavailability of the photosensitive resins. The reason is that the amino group of diamine chain extender has an addition reaction with other polyurethane acrylate oligomers in photosensitive resin or double bonds in reactive diluent, thus reducing the storage stability of the photosensitive resin.

The above is only the preferred embodiments of the disclosure, but the protection scope of the disclosure is not limited to this. Any change or replacement that may be easily thought of by a person familiar with this technical field within the technical scope disclosed in the disclosure should be included in the protection scope of the disclosure. Therefore, the protection scope of the disclosure should be based on the protection scope of the claims.

What is claimed is:

1. A dual-cured photosensitive resin, wherein raw materials comprise a polyurethane acrylate prepolymer bearing hindered urea bonds and a blocked diamine chain extender;
the blocked diamine chain extender is obtained by reacting a diamine chain extender with one of di-tert-butyl dicarbonate, acid and inorganic salt.

2. The dual-cured photosensitive resin according to claim 1, wherein the diamine chain extender is aliphatic diamine, alicyclic diamine or aromatic diamine.

3. The dual-cured photosensitive resin according to claim 2, wherein the diamine chain extender is aromatic diamine.

4. The dual-cured photosensitive resin according to claim 3, wherein the diamine chain extender is one of 4,4′-methylene bis(2-chloroaniline), 4,4′-diphenylmethane diamine, p-phenylenediamine and 4,4′-methylene dicyclohexylamine.

5. The dual-cured photosensitive resin according to claim 1, wherein a molar ratio of the polyurethane acrylate prepolymer bearing hindered urea bonds to the blocked diamine chain extender is 1:1.

6. The dual-cured photosensitive resin according to claim 1, wherein a structural formula of the polyurethane acrylate prepolymer bearing hindered urea bonds is:

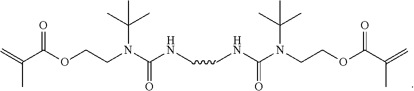 [SMILES: C=C(C)C(=O)OCCN(C(=O)NCCNC(=O)N(CCOC(=O)C(=C)C)C(C)(C)C)C(C)(C)C]

7. The dual-cured photosensitive resin according to claim 1, wherein the raw materials further comprise a reactive diluent and a photoinitiator.

8. A preparation method of the dual-cured photosensitive resin according to claim 1, comprising: uniformly mixing raw materials of the polyurethane acrylate prepolymer bearing hindered urea bonds, the blocked diamine chain extender, the reactive diluent and the photoinitiator to obtain the dual-cured photosensitive resin.

9. An application of the dual-cured photosensitive resin according to claim 1 in preparing coatings, inks or adhesives, wherein the dual-cured photosensitive resin needs to undergo heat treatment after photo-curing, and a temperature of the heat treatment is 100-140° C. and a duration is 30 min-4 h.

10. An application of the dual-cured photosensitive resin according to claim 1 in photo-curing 3D printing, wherein the photo-curing 3D printing comprises printing with top-down stereo lithography apparatus and bottom-up digital light processing or laser cladding deposition 3D printing equipment, and performing heat treatment after printing and molding, and a temperature of the heat treatment is 100-140° C. and a duration is 30 min-4 h.
